(19) United States
(12) Patent Application Publication
(10) Pub. No.: US 2020/0148921 A1
(43) Pub. Date: May 14, 2020

(54) CHLOROPRENE ADHESIVE SYSTEM

(71) Applicant: REMA TIP TOP AG, Poing (DE)

(72) Inventors: Angela MÜCKE, Schwaben (DE); Helmut DEGENBECK, München (DE)

(21) Appl. No.: 16/614,334

(22) PCT Filed: May 17, 2018
(86) PCT No.: PCT/EP2018/062946

§ 371 Date: Nov. 15, 2019

(30) Foreign Application Priority Data
May 17, 2017 (DE) 10 2017 208 338.7

(51) Int. Cl. C09J 111/00

(52) U.S. Cl. CPC C09J 111/00

(57) ABSTRACT

The chloroprene adhesive system according to the invention guarantees, even at high temperatures, improved stability of the adhesive bond compared to an adhesive bond produced using conventional multi-component adhesives. The chloroprene adhesive system comprises a first component (A), which contains inter alia an unsaturated elastomer, in particular chloroprene rubber. In addition, the first component (A) comprises an additive, in particular a metal oxide and preferably zinc oxide. Furthermore, the chloroprene adhesive system contains as a second component (B) a halogenated reactive curing resin and preferably a brominated reactive curing resin.

### CROSS-REFERENCE TO RELATED APPLICATIONS

This application is the U.S. National Stage entry under 35 U.S.C. § 371 of international application PCT/EP2018/062946, filed 17 May 2018, which in turn claims priority to German patent application 10 2017 208338.7, filed 17 May 2019.

### FIELD OF THE INVENTION

The invention relates to a chloroprene adhesive system which guarantees improved stability compared to conventional multi-component adhesives even at high temperatures.

### BACKGROUND

Common multi-component adhesives, which can be used for rubber-rubber, rubber-fabric, rubber-metal and fabric-fabric bonding, show insufficient strength after being applied and cured, in particular in the high temperature range under mechanical stress. The longer the high temperature load acts on the adhesive bond, the lower its resistance to mechanical stress, e.g. to peeling or shearing, tends to be. Since the achievable load capacity of the adhesive bond is too low, it is to date not possible in some cases to use it at all, which usually results in enormous costs for replacement instead of repair. Otherwise, there is a risk of failure under load, which in turn could result in serious consequential damage. Some common multi-component adhesives try to increase their resistance to mechanical stress by using isocyanates which are, however, harmful to health and should therefore only be used when certain precautions are taken.

### BRIEF DESCRIPTION OF THE FIGURES

FIG. 1 is a graph comparing the peel resistance of aspects of the disclosed chloroprene adhesive system (C-K-S) with the peeling resistance of a commercially available reference two-component adhesive (Ref-K) over several time periods. The case shown in the graph is of an exposure of the bonding to a temperature of 120° C.

FIG. 2 is a graph comparing the peel resistance of aspects of the disclosed chloroprene adhesive system (C-K-S) with the peeling resistance of a commercially available reference two-component adhesive (Ref-K) over several time periods. The case shown in the graph is an exposure of the Ref-K adhesive to a temperature of 120° C. and a correspondingly long exposure of the C-K-S bonding to a temperature of 140° C.

### DETAILED DESCRIPTION

The object of the invention is therefore to provide an adhesive bond that has improved stability, in particular also in the high-temperature range, i.e. thermal stability, and completely dispenses with the use of isocyanates. A simple and safe application shall be made possible for the end user.

In order to achieve this object, a chloroprene adhesive system with the features mentioned in claim 1 is proposed.

Such a chloroprene adhesive system comprises a first component (A) containing an unsaturated elastomer, in particular chloroprene rubber, and an additive, in particular a metal oxide, and preferably zinc oxide in the range of 10<phr<40. Furthermore, the chloroprene adhesive system can contain a second component (B), which can be a halogenated reactive curing resin and preferably a brominated reactive curing resin. The stoichiometric ratio of the first component (A) to the second component (B) can be 100/15 to 100/1, preferably 100/10 to 100/4.

After mixing the first component (A) and the second component (B), a ready-to-use chloroprene adhesive system is formed, which can have a pot life of several days to weeks at room temperature. This means that the pot life—and therefore also the applicability—of the chloroprene adhesive system is considerably longer than that of conventional multi-component adhesives after mixing. The finished adhesive bond has an increased stability compared to conventional multi-component adhesives. The adhesive strength on high-energy or polarizable surfaces, such as metal surfaces, is also improved by the chloroprene adhesive system compared to conventional multi-component adhesives.

The dependent claims relate to advantageous embodiments and further developments of the invention.

The elements of the first component (A) can first be mixed and then be dissolved, the concentration of a first solution being 20 to 28 weight percent and a more preferred concentration being 22 to 26 weight percent, in order to achieve a viscosity advantageous for use in the case of a suitable application of solids and a particularly high strength. The first component (A) can be dissolved independently of the second component (B).

The elements of the second component (B) can first be mixed and then be dissolved, the concentration of a second solution being 30 to 60 weight percent and a more preferred concentration being 35 to 50 weight percent. This serves to achieve the highest possible strength and thermal stability of the chloroprene adhesive system.

In order to dissolve the first component (A) and the second component (B), a cyclohexane-ethyl acetate solution can be used in each case, which can more preferably have a weight ratio of about 1:1. The cyclohexane-ethyl acetate solution does not participate in the other relevant reactions of the chloroprene adhesive system.

The two dissolved components of the chloroprene adhesive system can be mixed at a temperature of between 10° C. and 40° C. This facilitates in a general way the applicability and field of use of the chloroprene adhesive system.

After mixing, the chloroprene adhesive system can have a dynamic viscosity of 500-5,000 mPa·s (millipascal seconds) at 20° C., and preferably it can have a dynamic viscosity of 1,500-3,000 mPa·s. It can thus be applied to the surfaces to be treated in an optimum way.

After mixing and a possible application with a temperature increase to at least 60° C., the chloroprene adhesive system can automatically initiate a reaction which can cause additional curing. The chloroprene can be cross-linked in a non-reversible way in particular by activating the reactive curing resin as from 60° C. This temperature increase can also take place after bonding during operation; e.g. in the case of a conveyor belt exposed to strong solar radiation or a component in the waste heat area of a motor. The additional curing also increases in particular the heat stability of the adhesive bond.

Furthermore, the additional curing can be intentionally and specifically carried out by heating using an infrared radiator or another temperature source at 80° C. to 120° C. for 40 min to 80 min, preferably at 100° C. for about 60 min. The improved thermal stability can thus be guaranteed.

Moreover, additional curing can take place in an autoclave at 98° C. and 6 bar pressure for 3.5 hours. The targeted adaptation of the ambient conditions thus guarantees improved thermal stability.

The first component (A) or the second component (B) can contain an additive, in particular a dye or an antioxidant. A dye can be used to test the homogeneity of the mixture of the two dissolved components in the chloroprene adhesive system. In addition, a dye also allows to clearly mark repaired areas.

The chloroprene adhesive system comprises a first component (A), which contains inter alia an unsaturated elastomer, in particular a chloroprene rubber. Instead of the exclusive use of chloroprene rubber, the system can also contain a blend of chloroprene rubber with other unsaturated rubber mixtures or blends of other unsaturated rubber mixtures. In addition, the first component (A) comprises an additive, in particular a metal oxide and preferably zinc oxide in the range of 10<phr<40. The first component (A) more preferably comprises zinc oxide in the range of 20<phr<35 since here inter alia its property as an acid scavenger and crosslinking aid manifests itself in an optimum way. Furthermore, the chloroprene adhesive system contains a second component (B), namely a halogenated reactive curing resin and preferably a brominated reactive curing resin, which inter alia considerably improves the thermal stability of the chloroprene adhesive system. The stoichiometric ratio of the first component (A) to the second component (B) is 100/15 to 100/1, preferably 100/10 to 100/4, in order to also achieve in particular an optimum thermal stability for the chloroprene adhesive system.

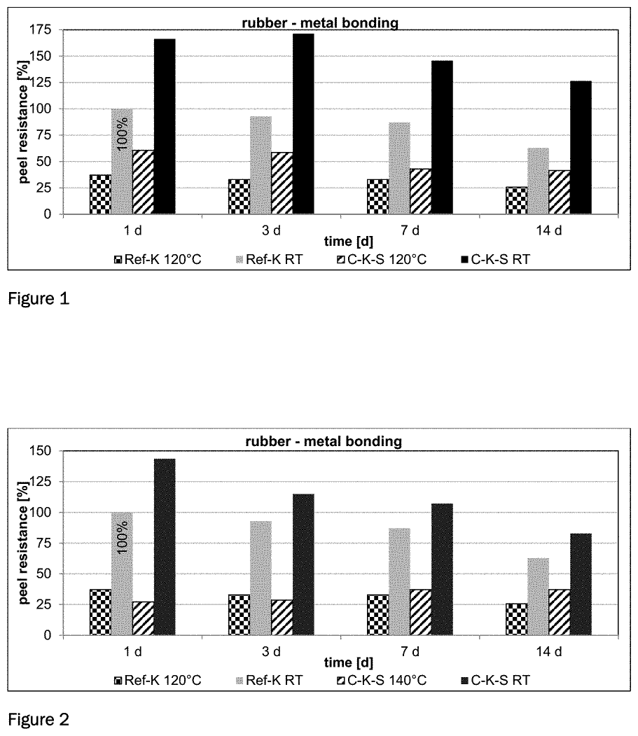

FIG. 1 compares the chloroprene adhesive system (C-K-S) with a commercially available reference two-component adhesive (Ref-K) in the case of an exposure of the bonding to a temperature of 120° C. possibly for several days. The peel resistance is measured after exposing the bonding at least for one day to a temperature of 120° C. both in the warm state and after a further one-day cooling phase to room temperature. A rubber-metal bonding was evaluated as an example. Here, the rubber layer can be e.g. a chloroprene-containing layer which represents a semi-pre-vulcanized layer. Furthermore, a commercially available primer can be used for the pretreatment of metal surfaces in soft rubber coatings. First, the peel resistance of the bonding is standardized to 100% using the commercially available reference two-component adhesive. Before this reference peel resistance was determined, the bonding was first carried out by applying a thin layer of the mixed reference two-component adhesive (Ref-K) and subsequently pressing it hard for a short time; thereafter, the workpiece was kept hot for one day at a temperature of 120° C. and then cooled down to room temperature for a further day. All further values in FIG. 1 refer to this reference peel resistance of 100%. In the following, the sequence of the peel resistance determination is described on the basis of the duration of the temperature exposure. First, the bonded workpieces (the adhesive bonds) are stored for one day at a temperature of 120° C.

Diagram data for one day: the peel resistance values determined during the exposure to an increased temperature for the reference two-component adhesive (Ref-K) and for the chloroprene adhesive system (C-K-S) are obtained immediately after this one-day storage at a temperature of 120° C. The peel resistance values determined at room temperature for the reference two-component adhesive (Ref-K) and for the chloroprene adhesive system (C-K-S) are obtained after a further one-day cooling phase following one-day storage at a temperature of 120° C.

Diagram data for three days: the peel resistance values determined during the exposure to an increased temperature for the reference two-component adhesive (Ref-K) and for the chloroprene adhesive system (C-K-S) are carried out immediately after this three-day storage at a temperature of 120° C. The peel resistance values determined at room temperature for the reference two-component adhesive (Ref-K) and for the chloroprene adhesive system (C-K-S) are obtained after a further one-day cooling phase following the three-day storage at a temperature of 120° C.

Diagram data for seven days: the peel resistance values determined during the exposure to an increased temperature for the reference two-component adhesive (Ref-K) and for the chloroprene adhesive system (C-K-S) are carried out immediately after this seven-day storage at a temperature of 12° C. The peel resistance values determined at room temperature for the reference two-component adhesive (Ref-K) and for the chloroprene adhesive system (C-K-S) are obtained after a further one-day cooling phase following the seven-day storage at a temperature of 120° C.

Diagram data for fourteen days: the peel resistance values determined during the exposure to an increased temperature for the reference two-component adhesive (Ref-K) and for the chloroprene adhesive system (C-K-S) are obtained immediately after this fourteen-day storage at a temperature of 120° C. The peel resistance values determined at room temperature for the reference two-component adhesive (Ref-K) and for the chloroprene adhesive system (C-K-S) are obtained after a further one-day cooling phase following the fourteen-day storage at a temperature of 120° C.

One advantage of the chloroprene adhesive system is that its pot life far exceeds that of a commercially available reference two-component adhesive. After mixing the first component (A) with the second component (B), the chloroprene adhesive system can be kept ready for use for well over a week without any negative effect on the adhesive bond to be created.

The initial adhesive strength of the chloroprene adhesive system at room temperature is equivalent to the initial adhesive strength of the reference two-component adhesive (not shown in FIG. 1). Curing takes place here by crystallization of the chloroprene.

In the chloroprene adhesive system, the second component (B) is activated as temperatures rise, so that chemical cross-linking takes additionally place through the curing resin. The polar chloroprene adhesive system generally has advantages in terms of the strength of the adhesive bond on high-energy or polarizable surfaces, such as metal surfaces.

As shown in FIG. 1, the peel resistance value of the chloroprene adhesive system (C-K-S 120° C.) determined immediately after the one-day storage of the bonded workpiece at a temperature of 120° C. is significantly—i.e. over 60%—higher than the peel resistance value determined during bonding using the reference two-component adhesive (Ref-K 120° C.). This is partly due to the fact that, when the temperature of the adhesive bond produced by the chloroprene adhesive system increases to a temperature of at least 60° C., an additional chemical cross-linking takes place automatically that is essentially irreversible—which, in turn, is important for determining the peel resistance values at room temperature. Cross-linking takes place at double bonds (of the unsaturated elastomer, preferably of the chloroprene rubber) via methylol/bromomethyl groups (of the halogenated reactive curing resin). The fact that, when exposed to a temperature of 120° C., the peel resistance values are below the reference value of 100% (Ref-K RT) is due to the predominantly reversible softening of the chloroprene-crystal bond with increasing temperature; when cooled, the chloroprene crystallizes again. The metal oxide supports the activation of the halogenated reactive curing resin and thus fulfils an advantageous dual function since it also supports the cross-linking between the chloroprene rubber molecules. By means of the chloroprene adhesive system, a significant increase in temperature stability can be achieved since the chemical cross-linking due to the halogenated reactive curing resin counteracts the softening of the chloroprene crystal compound with increasing temperature. Another advantage is that, compared to normal phenolic resins, the employed halogenated reactive curing resin shows a significantly higher cross-linking speed with chloroprenes. Compared to isocyanates, the advantageous omission of a pot life limiting the processing window can be mentioned. The mixed chloroprene adhesive system can be processed over several days to weeks since the cross-linking essentially only begins at higher temperatures. The rubber cross-linked in this way has a significantly higher softening temperature.

The peel resistance values determined at room temperature for the reference two-component adhesive (Ref-K RT)—100%—and for the chloroprene adhesive system (C-K-S RT) after a further one-day cooling phase following one-day storage at a temperature of 120° C. also show a peel resistance value for the chloroprene adhesive system which is over 60% higher (compared with the two-component adhesive). Given a comparable initial adhesive strength, one-day warming to a temperature of 120° C. and subsequent cooling results in a significantly higher peel resistance value for the chloroprene adhesive system even at room temperature.

The peel resistance values determined during an increased three-day exposure to a temperature of 120° C. for the reference two-component adhesive (Ref-K 120° C.) and for the chloroprene adhesive system (C-K-S 120° C.) even show a peel resistance for the adhesive bond by means of the chloroprene adhesive system that is more than 70% higher than that of the adhesive bond by means of the reference two-component adhesive, even if both values are somewhat lower in absolute terms than in the case of a one-day exposure to a temperature of 120° C. A further softening of the chloroprene crystal compound with increasing temperature and duration is offset by an at least partial further cross-linking by the second component (B).

This can also be seen from the peel resistance values determined at room temperature for the reference two-component adhesive (Ref-K RT) and for the chloroprene adhesive system (C-K-S RT), which were determined after a further one-day cooling phase following the three-day storage at a temperature of 120° C. The adhesive bond by means of the chloroprene adhesive system now has a slightly higher value in absolute terms than it did after a one-day exposure to a temperature of 120° C. The adhesive bond by means of the reference two-component adhesive now has a slightly lower value in absolute terms than it did after a one-day exposure to a temperature of 120° C. The peel resistance of the adhesive bond by means of the chloroprene adhesive system is now over 80% higher than that of the adhesive bond by means of the reference two-component adhesive. Consequently, the thermal stability of the chloroprene adhesive system is considerably higher.

The peel resistance values determined during increased seven-day exposure to a temperature of 120° C. also show a significantly higher peel resistance for the adhesive bond using the chloroprene adhesive system (C-K-S 120° C.) compared to the adhesive bond using the reference two-component adhesive (Ref-K 120° C.), and the same applies to the peel resistance values determined at room temperature for the reference two-component adhesive (Ref-K RT) and for the chloroprene adhesive system (C-K-S RT), which were determined after a further one-day cooling phase following the seven-day storage at a temperature of 120° C.

If one considers the fourteen-day exposure to a temperature of 120° C., it can also be seen that the peel resistance of the adhesive bond by means of the chloroprene adhesive system (C-K-S 120° C.) is over 60% higher than that of the adhesive bond by means of the reference two-component adhesive (Ref-K 120° C.), and after a subsequent one-day cooling phase to room temperature, the peel resistance of the adhesive bond by means of the chloroprene adhesive system (C-K-S RT) is even more than 100% higher than that of the adhesive bond by means of the reference two-component adhesive (Ref-K RT). The superiority of the chloroprene adhesive system is also shown in particular by the fact that, after a fourteen-day exposure to a temperature of 120° C. and a subsequent one-day cooling phase to room temperature, the peel resistance of the adhesive bond by means of the chloroprene adhesive system is exceeded by more than 25% compared to the adhesive bond by means of the reference two-component adhesive, which has only been subjected to a one-day exposure to a temperature of 120° C. and has then been cooled down to room temperature for one day.

The peel resistance of the adhesive bond by means of the chloroprene adhesive system exceeds that of the adhesive bond by means of the reference two-component adhesive and at the same time can completely dispense with the use of isocyanates.

FIG. 2 compares the chloroprene adhesive system (C-K-S) with a commercially available reference two-component adhesive (Ref-K) in the case of a multi-day exposure of the bonding to a temperature of 120° C. for the reference two-component adhesive (Ref-K) and a correspondingly long exposure of the bonding to a temperature of 140° C. for the chloroprene adhesive system (C-K-S). All peel resistance values of the reference two-component adhesive from FIG. 2 are therefore consistent with those from FIG. 1.

The duration of the temperature application in FIG. 2 and FIG. 1 is carried out analogously. The diagram data for seven days therefore result, for example, from peel tests carried out immediately after seven-day storage at a temperature of 120° C. for the reference two-component adhesive (Ref-K 120° C.) and immediately after seven-day storage at a temperature of 140° C. for the chloroprene adhesive system (C-K-S 140° C.). The peel resistance values determined at room temperature for the reference two-component adhesive (Ref-K RT) and for the chloroprene adhesive system (C-K-S RT) are again obtained after a further one-day cooling phase following the seven-day storage at a temperature of 120° C. for the reference two-component adhesive and following a seven-day storage at a temperature of 140° C. for the chloroprene adhesive system.

As can be seen from FIG. 2, even though the bonding is exposed to a temperature of 140° C. for the chloroprene adhesive system, after cooling to room temperature it is always more stable than the reference two-component adhesive exposed to a temperature of 120° C. for a correspondingly long time. The main reason for this is the additional chemical cross-linking by the halogenated reactive curing resin.

The temperature-induced additional chemical cross-linking by the halogenated reactive curing resin exceeds the reference two-component adhesive (Ref-K) regarding its ability to counteract the temperature-induced softening of the chloroprene crystal bond after only a few days. In spite of a seven-day exposure to a temperature of 140° C., the adhesive bond of the chloroprene adhesive system thus has a peel resistance that is more than 10% higher than that of the adhesive bond by means of the reference two-component adhesive in the case of seven-day exposure at 120° C. After a fourteen-day exposure to a temperature of 140° C., the adhesive bond of the chloroprene adhesive system (C-K-S 140° C.) shows a peel resistance that is even more than 40% higher than that of the adhesive bond by means of the reference two-component adhesive (Ref-K 120° C.) in the case of a fourteen-day exposure to a temperature of 120° C. This means that with increasing duration of temperature exposure, the chloroprene adhesive system shows more and more its superiority over the reference two-component adhesive and is able to counteract the temperature-induced material stress more strongly.

One advantage of the chloroprene adhesive system is in particular that heating is only necessary if the initial adhesive strength of the chloroprene adhesive system, which at room temperature corresponds to the initial adhesive strength of the reference two-component adhesive, has to be exceeded. In the case that a higher stability is required or a higher thermal stability is required, the heating of the bond can advantageously be effected in a targeted and intentional manner but in many applications the automatic heating in operation can also be used. Here, for example, an adhesive bond of a conveyor belt exposed to strong sunlight or an adhesive bond used in the waste heat area of a motor on a component can be mentioned. In particular in the area of conveyor belt systems, the costs of a repair can therefore be considerably reduced since the high initial strength of the adhesive bond using the chloroprene adhesive system means that longer down times can be dispensed with. The system can be restarted very shortly after the adhesive bond has been established and the adhesive bond achieves a further increase in strength during operation. In any case, bonding using the chloroprene adhesive system has a higher thermal stability than bonding using the reference two-component adhesive at the same temperature. Advantageously, this additional strength is achieved by automatic additional cross-linking. This additional cross-linking, which also serves safety considerably since it counteracts a dangerous softening of the chloroprene with increasing temperature, is therefore an advantageous inherent property of the chloroprene adhesive system according to the invention.

In the case of very high required strengths, these strengths can be securely produced in the adhesive bond by targeted heating and thus allow a safe use.

The elements of the first component (A) can advantageously first be mixed and then be dissolved, the concentration of a first solution being 20 to 28 weight percent and a more preferred concentration being 22 to 26 weight percent, in order to achieve a viscosity advantageous for the application and a suitable application of solid as well as a particularly high strength. Although the high thermal stability of the chloroprene adhesive system requires the subsequent mixing with the second component (B), the first component (A) is dissolved independently of the second component (B). It is therefore possible to produce, fill or store the first component (A) completely separately from the second component (B), which results in advantages with regard to cost and logistics.

The elements of the second component (B) can advantageously be mixed first and then be dissolved, the concentration of a second solution being 30 to 60 weight percent and a more preferred concentration being 35 to 50% by weight. This also serves to achieve the highest possible strength and thermal stability of an adhesive bond produced using the chloroprene adhesive system. Another advantage is that production, filling and, for example, packaging of the second component (B) can take place completely independently of the first component (A). Both components can, for example, be produced at one or more locations simultaneously. However, it is also possible, for example, to produce first the second component (B) and then the first component (A) at one location.

In order to dissolve the first component (A) and the second component (B), a cyclohexane-ethyl acetate solution can be used in each case, which preferably has a weight ratio of 1:1. Due to the small differences in density between cyclohexane and ethyl acetate, a volume ratio of 1:1 is also possible. It is advantageous that the cyclohexane-ethyl acetate solution can be used to dissolve both the first component (A) and the second component (B). The cyclohexane-ethyl acetate solution does not participate in the other relevant reactions of the chloroprene adhesive system. Toluene, which is harmful to health, can be completely dispensed with.

The two dissolved components of the chloroprene adhesive system can advantageously be mixed at a temperature of between 10° C. and 40° C. This facilitates in a general way the applicability and the field of use of the chloroprene adhesive system. Mixing does not generate any heat and can therefore be carried out in virtually any quantity by simple stirring until homogeneous mixing of the first component (A) and the second component (B) has already taken place after a short time. Depending on the quantity, mixing can be carried out manually, with a mixer or in a stirrer. Fully automatic mixing is also conceivable. The extremely long pot life of the mixed chloroprene adhesive system favors the repeated production of larger quantities.

After mixing, the chloroprene adhesive system can advantageously have a dynamic viscosity of 500-5,000 mPa·s (millipascal seconds) at 20° C., preferably it has a dynamic viscosity of 1,500-3,000 mPa·s. It can thus be optimally applied to the surfaces to be treated and a wide variety of brushes, rollers and rolls can be used for application. There is no need for expensive special tools.

After using the mixed chloroprene adhesive system and increasing the temperature of the adhesive bond to at least 60° C., the chloroprene adhesive system can automatically initiate a reaction that can cause additional curing. In particular by activation of the reactive curing resin in the chloroprene adhesive system, which starts from 60° C., a non-reversible cross-linking of the chloroprene can take place. This additional curing also increases in particular the thermal stability of the adhesive bond. Advantageously, the increased resistance to mechanical stress—compared to the adhesive bond which is not exposed to a temperature increase—is maintained even after cooling. The resistance of the adhesive bond produced with the chloroprene adhesive system can therefore be increased in the desired manner by targeted heating. The temperature increase in the adhesive bond produced by the chloroprene adhesive system can also take place during operation of the repaired component—in particular due to the high initial strength that can be achieved; for example, in the case of a conveyor belt exposed to strong solar radiation or a component in the waste heat area of a motor. Long and cost-intensive downtimes can thus be avoided.

Furthermore, the additional curing of the adhesive bond produced by means of the chloroprene adhesive system can be carried out intentionally and specifically by heating at 80° C. to 120° C. for 40 min to 80 min, preferably at 100° C. for about 60 min. An infrared radiator or another suitable temperature source can be used for targeted heating. The improved thermal stability of the adhesive bond produced by means of the chloroprene adhesive system can thus be achieved in a targeted manner and the increased resistance can thus be guaranteed. Depending on the type of temperature source, it is also advantageous to use suitable temperature profiles which increase the resistance of the adhesive bond produced by means of the chloroprene adhesive system.

Furthermore, the additional curing of the adhesive bond produced by the chloroprene adhesive system can also be carried out in an autoclave at 98° C. and 6 bar pressure for 3.5 h. The targeted adjustment of pressure and temperature over a certain period of time thus guarantees an improved thermal stability of the adhesive bond produced by means of the chloroprene adhesive system. It is also conceivable that certain pressure and/or temperature profiles can be used in the autoclave to further increase the mechanical resistance of the adhesive bond produced by means of the chloroprene adhesive system.

The advantageous addition of a dye causes a simple visual check of the homogeneity of the mixed first component (A) with the second component (B) as well as a clear marking of a repaired area. In addition, the size of the repair is clearly indicated. Such a marking is also very useful for conveyor belts. The addition of an antioxidant to the first component (A) or the second component (B) also serves to improve the situation correspondingly.

The individual features of the invention are, of course, not limited to the combinations of features described on the basis of the embodiments presented, and can also be used in other combinations depending on the predefined parameters.

1-10. (canceled)

11. A chloroprene adhesive system comprising a first component (A) and a second component (B),
wherein the first component (A) contains an unsaturated elastomer and a metal oxide additive;
wherein the second component (B) contains a halogenated reactive curing resin; and
wherein the stoichiometric ratio of the first component (A) to the second component (B) is 100/15 to 100/1.

12. The chloroprene adhesive system of claim 11 wherein the unsaturated elastomer is chloroprene rubber or a blend of chloroprene rubber with other unsaturated rubber mixtures.

13. The chloroprene adhesive system of claim 11 wherein the metal oxide additive is zinc oxide in the range of 10<phr<40.

14. The chloroprene adhesive system of claim 11 wherein the metal oxide additive is zinc oxide in the range of 20<phr<35.

15. The chloroprene adhesive system of claim 11 wherein the halogenated reactive curing resin is a brominated reactive curing resin.

16. The chloroprene adhesive system of claim 11 wherein the stoichiometric ratio of the first component (A) to the second component (B) is 100/10 to 100/4.

17. The chloroprene adhesive system of claim 11 wherein the first component (A) is first mixed and then dissolved to form a first solution having a concentration of 20 to 28 weight percent.

18. The chloroprene adhesive system of claim 11 wherein the concentration of the first solution is 22 to 26 weight percent.

19. The chloroprene adhesive system of claim 11 wherein the second component (B) is first mixed and then dissolved to form a second solution with a concentration of 30 to 60 weight percent.

20. The chloroprene adhesive system of claim 11 wherein the concentration of the second solution is 35 to 50 weight percent.

21. The chloroprene adhesive system of claim 11 wherein a cyclohexane-ethyl acetate solution is used for dissolving, which solution has a weight ratio of 1:1.

22. The chloroprene adhesive system of claim 11 wherein the two dissolved components are mixed at a temperature between 10° C. and 40° C.

23. The chloroprene adhesive system of claim 11 wherein, after mixing, the chloroprene adhesive system has a dynamic viscosity of 500-5,000 mPa·s (millipascal seconds) at 20° C.

24. The chloroprene adhesive system of claim 23 wherein the chloroprene adhesive system has a dynamic viscosity of 1,500-3,000 mPa·s (millipascal seconds).

25. The chloroprene adhesive system of claim 11 wherein, after mixing and a possible application, additional cross-linking automatically takes place when the temperature is increased to at least 60° C.

26. The chloroprene adhesive system of claim 25 wherein the additional cross-linking is effected by heating using an infrared radiator or another temperature source at 80° C. to 120° C. for 40 min to 80 min.

27. The chloroprene adhesive system of claim 25 wherein the additional cross-linking is effected by heating using an infrared radiator or another temperature source at 100° C. for 60 min.

28. The chloroprene adhesive system of claim 11 wherein the additional curing takes place in an autoclave at 98° C. and 6 bar pressure for 3.5 hours.

29. The chloroprene adhesive system of claim 11 wherein the first component (A) or the second component (B) contains an additive, the additive being a dye or an antioxidant.
